(19) United States
(12) Patent Application Publication
(10) Pub. No.: US 2006/0264228 A1
(43) Pub. Date: Nov. 23, 2006

(54) METHOD FOR SWITCHING BETWEEN FIRST AND SECOND COMMUNICATION CHANNELS ON A MOBILE TELEPHONE

(76) Inventor: Jay Wertheimer, Atlanta, GA (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/383,810

(22) Filed: May 17, 2006

Related U.S. Application Data
(60) Provisional application No. 60/681,773, filed on May 17, 2005.

(51) Int. Cl. H04B 7/00

(52) U.S. Cl. 455/513; 455/525; 455/509; 455/550.1

(57) ABSTRACT

A method for use with a wireless telephone establishing a primary signal strength associated with a primary communication channel and establishing a secondary signal strength associated with a secondary communication channel. The method also allows a user of the wireless telephone to switch between the primary communication channel and secondary communication channel.

### CROSS-REFERENCE TO RELATED APPLICATION

The instant application claims priority to U.S. Provisional Patent Application Ser. No. 60/681,773, filed May 17, 2005, the entire specification of which is expressly incorporated herein by reference.

### FIELD OF THE INVENTION

The present invention relates generally to mobile communication devices, such as telephones, and more particularly to a system and method for switching between first and second communication channels on a mobile telephone.

### BACKGROUND OF THE INVENTION

Cellular telephones are seemingly ubiquitous and are now an integral and necessary part of daily life for a large number of people.

Cellular telephone service is provided by a relatively few number of providers, e.g. SPRINT™, VERIZON™, AT&T™, NEXTEL™, T-MOBILE™, and the like. Early cellular telephones were analog. Current cellular phones use digital communication channels or bands. However, some cellular phones have the ability to operate on an analog channel and/or one or more digital channels.

In the United States, cellular telephones can generally operate on an 800 MHz analog channel, an 800 MHz digital channel, and/or a 1900 MHz digital channel. The digital channels use Code-Division Multiple Access (CDMA) digital cellular technology. Additionally, some cellular telephones may also be able to operate on international channel or band, such as the Global System for Mobile (GSM) service that uses Time Division Multiple Access (TDMA) digital wireless technology service.

There are generally four types of phones available: (1) single-band phones, (2) dual-band phones, (3) tri-mode phones; and (4) digital quad-band. The type of phones being used determines which bands or channels may be used. Typically, purchase of a service plan will give access to different bands within a service provider's network. For example, use of a single band mobile phone will provide access to only one band or channel on the service provider's network.

Service providers will typically provide “roaming access” to other service provider's network. For example, if a user is currently in a location in which their own service provider does not have coverage, but the user's telephone detects another service providers's network, an indicator of roaming access, such as an “R,” will be provided on the telephone's display. This is generally automatic and works only between calls.

However, if the user is in a location where their service provider has access and their telephone can receive a signal from their service provider, the telephone will use the service provider's network, even if there is a stronger signal from another service provider.

The present invention is aimed at one or more of the problems set forth above.

### SUMMARY OF THE INVENTION

In accordance with a first embodiment of the present invention, a method for use with a wireless telephone is provided, comprising establishing a primary signal strength associated with a primary communication channel, establishing a secondary signal strength associated with a secondary communication channel, and allowing a user of the wireless telephone to switch between the primary communication channel and secondary communication channel.

In accordance with a first alternative embodiment of the present invention, a method for use with a wireless telephone is provided, comprising establishing a primary signal strength associated with a primary communication channel, establishing a secondary signal strength associated with a secondary communication channel, allowing a user of the wireless telephone to switch between the primary communication channel and secondary communication channel, and providing an indicia to the user of the strengths of the primary communication channel and the secondary communication channel.

In accordance with a second alternative embodiment of the present invention, a method for use with a wireless telephone, comprising: establishing a primary signal strength associated with a primary communication channel, establishing a secondary signal strength associated with a secondary communication channel, allowing a user of the wireless telephone to switch between the primary communication channel and secondary communication channel, providing an indicia to the user of the strengths of the primary communication channel and the secondary communication channel, and allowing the user to select one of the primary communication channel and the second communication channel to use.

Further areas of applicability of the present invention will become apparent from the detailed description provided hereinafter. It should be understood that the detailed description and specific examples, while indicating the preferred embodiment of the invention, are intended for purposed of illustration only and are not intended to limit the scope of the invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a diagrammatic illustration of a mobile phone having a display screen for allowing a user to switch between first and second communication channels, according to an embodiment of the present invention;

FIG. 2 is a second diagrammatic illustration of the mobile phone of FIG. 1;

FIG. 3 is a diagrammatic illustration of the display screen of FIG. 1, according to an embodiment of the present invention; and

FIG. 4 is a flow diagram of a method for allowing a user of a mobile phone to switch between first and second communication channel, according to an embodiment of the present invention.

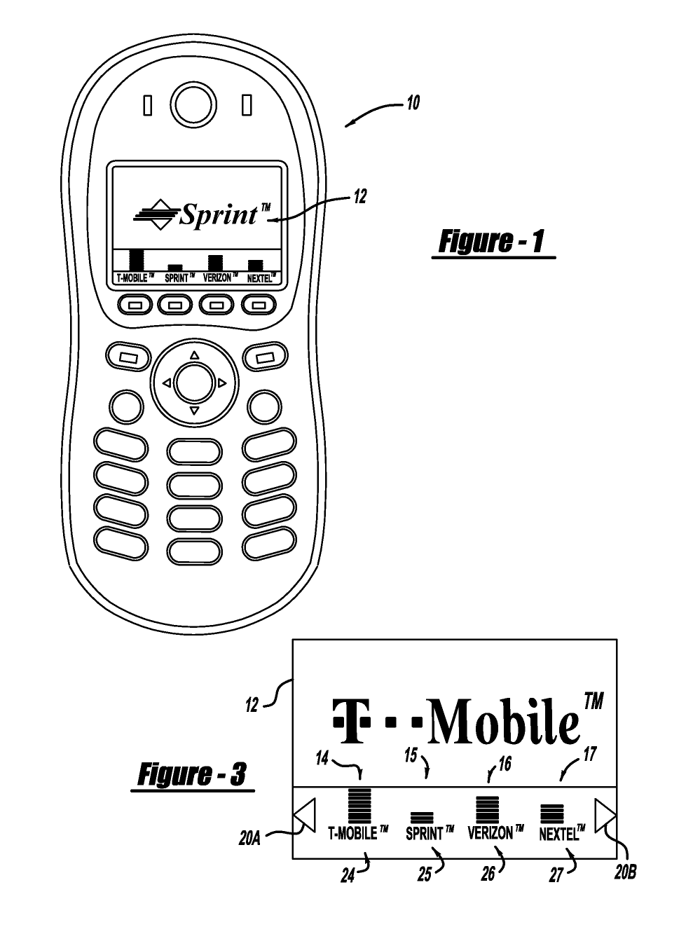

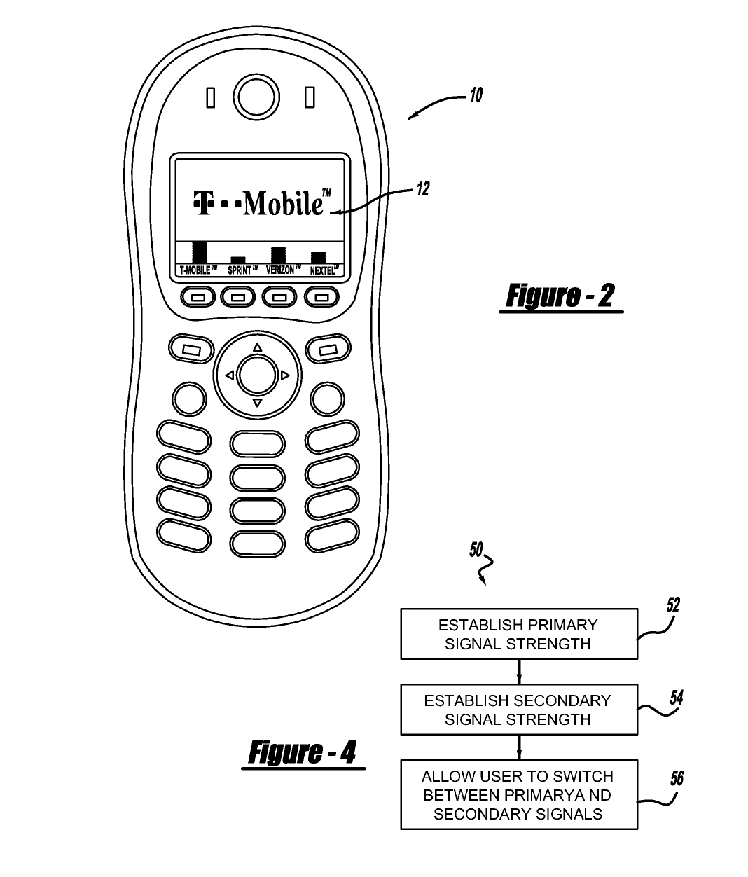

The same reference numerals refer to the same parts throughout the various Figures.

### DETAILED DESCRIPTION OF INVENTION

The following description of the preferred embodiment(s) is merely exemplary in nature and is in no way intended to limit the invention, or uses.

With reference to the drawings generally and in operation, the present invention relates to a mobile or cellular telephone 10. The user of the telephone 10 will generally have a service provider. Depending on the type of telephone 10 being used, the service provider, and/or the service contract, the telephone 10 may have access to one or more bands or channels within the service provider's network and/or access to one or more bands or channels within one or more alternative service providers' networks. It should also be appreciated that the specific service providers disclosed, e.g. SPRINT™, VERIZON™, AT&T™, NEXTEL™, T-MOBILE™, and the like are for illustrative purposes only, and that the present invention can be practiced with any particular service provider.

The bands or channels that may be available include, but are not limited to, 800 MHz analog, 800 Mhz CDMA, 1900 MHz CDMA, 800 MHZ GSM, and 1900 MHz GSM. That is, it is envisioned that if other bands or channels become available in the future, the present invention can also be practiced with those new bands or channels, as they become available.

With particular reference to FIG. 4, a method 50 for use with the telephone 10 will now be described. In a first step 52, a primary signal strength associated with a primary communication channel is established. In a second step 54, secondary signal strength associated with a secondary communication channel is established. In a third step 56, the user of the wireless telephone 10 is allowed to switch between the primary communication channel and secondary communication channel.

In one aspect of the present invention, the user is automatically switched to the stronger signal, between and/or during a telephone call. That is, the telephone 10 is provided with the selective capability of being able to automatically switch to the stronger signal without any action needed by the user.

In one embodiment, the primary and secondary communication channels are associated with the primary service provider. In another embodiment, the primary communication channel is associated with a primary service provider and the secondary communication channel is associated with a secondary service provider.

In another aspect of the present invention, the method 50 may include the step of providing indicia 24, 26 to the user of the strengths of the primary communication channel and the secondary communication channel. With particular reference to FIG. 3, the telephone 10 for example, may display on a display screen 12 a set of bars 14, 15, 16, 17 associated with each channel indicative of the strength of the signal from the respective channel. The display screen 12 may be a touchscreen display or the user may navigate through the display screen 12 using an interface panel 18.

In one embodiment, the user may cycle through the available communication channels using arrows 20A, 20B provided on the display screen 12. The user may select which communication channel to use by selecting the corresponding indicia 24, 25, 26, 27. That is, the user can selectively control which particular communication channel is to be utilized at any given time.

In one embodiment, the indicia 24, 25, 26, 27 may also indicate which service provider is associated with the corresponding channel.

In another embodiment, the indicia 24, 25, 26, 27 may also indicate the type of channel corresponding to the indicia 24, 25, 26, 27 (for example, 800 MHz CDMA or 1900 MHz CDMA).

Obviously, many modifications and variations of the present invention are possible in light of the above teachings. The invention may be practiced otherwise than as specifically described within the scope of the appended claims.

What is claimed is:

1. A method for use with a wireless telephone, comprising:
establishing a primary signal strength associated with a primary communication channel;
establishing a secondary signal strength associated with a secondary communication channel; and
allowing a user of the wireless telephone to switch between the primary communication channel and secondary communication channel.

2. The invention according to claim 1, wherein the primary communication channel is analog or digital and the secondary communication channel is analog or digital.

3. The invention according to claim 1, wherein the primary and secondary communication channels are associated with a primary service provider.

4. The invention according to claim 1, wherein the primary communication channel is associated with a primary service provider and the secondary communication channel is associated with an alternative service provider.

5. The invention according to claim 1, including the step of providing an indicia to the user of the strengths of the primary communication channel and the secondary communication channel.

6. The invention according to claim 5, including the step of allowing the user to select one of the primary communication channel and the second communication channel to use.

7. The invention according to claim 5, wherein the indicia of the strength of the primary and secondary communication channels include a set of bars for each communication channel.

8. The invention according to claim 6, wherein the indicia of the strength of the primary and secondary communication channel includes a service provider associated with each communication channel.

9. The invention according to claim 7, wherein the indicia of the strength of the primary and secondary communication channel includes a communication channel type associated with each channel.

10. A method for use with a wireless telephone, comprising:
establishing a primary signal strength associated with a primary communication channel;
establishing a secondary signal strength associated with a secondary communication channel;
allowing a user of the wireless telephone to switch between the primary communication channel and secondary conmiunication channel; and
providing an indicia to the user of the strengths of the primary communication channel and the secondary communication channel.

11. The invention according to claim 10, wherein the primary communication channel is analog or digital and the secondary communication channel is analog or digital.

12. The invention according to claim 10, wherein the primary and secondary communication channels are associated with a primary service provider.

13. The invention according to claim 10, wherein the primary communication channel is associated with a primary service provider and the secondary communication channel is associated with an alternative service provider.

14. The invention according to claim 10, including the step of allowing the user to select one of the primary communication channel and the second communication channel to use.

15. The invention according to claim 10, wherein the indicia of the strength of the primary and secondary communication channels include a set of bars for each communication channel.

16. The invention according to claim 15, wherein the indicia of the strength of the primary and secondary communication channel includes a service provider associated with each communication channel.

17. The invention according to claim 16, wherein the indicia of the strength of the primary and secondary communication channel includes a communication channel type associated with each channel.

19. A method for use with a wireless telephone, comprising:
establishing a primary signal strength associated with a primary communication channel;
establishing a secondary signal strength associated with a secondary communication channel;
allowing a user of the wireless telephone to switch between the primary communication channel and secondary communication channel;
providing an indicia to the user of the strengths of the primary communication channel and the secondary communication channel; and
allowing the user to select one of the primary communication channel and the second communication channel to use.

19. The invention according to claim 18, wherein the primary communication channel is associated with a primary service provider and the secondary comniunication channel is associated with an alternative service provider.

20. The invention according to claim 18, wherein the indicia of the strength of the primary and secondary communication channel includes a service provider associated with each conmiunication channel.
